(19) United States
(12) Patent Application Publication
(10) Pub. No.: US 2026/0118576 A1
(43) Pub. Date: Apr. 30, 2026

(54) TECHNOLOGIES FOR STACKED PHOTONIC INTEGRATED CIRCUIT DIES

(71) Applicant: Intel Corporation, Santa Clara, CA (US)

(72) Inventors: Benjamin T. Duong, Phoenix, AZ (US); Brandon Christian Marin, Gilbert, AZ (US); Kristof Darmawikarta, Chandler, AZ (US); Srinivas V. Pietambaram, Chandler, AZ (US); Gang Duan, Chandler, AZ (US); Sandeep Gaan, Chandler, AZ (US); Shereen Elhalawaty, Scottsdale, AZ (US); Marcel M. Said, Beaverton, OR (US); Liqiang Cui, Shenzhen (CN); Vinod Adivarahan, Chandler, AZ (US)

(73) Assignee: Intel Corporation, Santa Clara, CA (US)

(21) Appl. No.: 18/867,728

(22) PCT Filed: Jun. 24, 2022
(86) PCT No.: PCT/CN2022/100997

§ 371 Date: Nov. 20, 2024

(51) Int. Cl. G02B 6/12; G02B 6/13; G02B 6/42; G02B 6/43

(52) U.S. Cl. CPC G02B 6/12002; G02B 6/12004; G02B 6/13; G02B 6/4274; G02B 6/43

(57) ABSTRACT

Technologies for stacked photonic integrated circuit (PIC) dies are disclosed. In the illustrative embodiment, two or more PIC dies are stacked on top of each other, with an electronic integrated circuit (EIC) die stacked on top. The PIC dies may be optically coupled in any suitable manner, such as mirrors in an optical bridge, direct-write waveguides in an optical bridge, or photonic wire bonds. Stacking PIC dies may increase yield, reduce footprint, reduce cost, and allow for different PIC technologies to be integrated into one device.

### BACKGROUND

Photonic integrated circuits (PICs) can be used for several applications such as communications. As PICs scale up in size, yield can decrease, and the required package dimensions can increase as well, increasing the cost and potentially limiting the performance of PICs.

### BRIEF DESCRIPTION OF THE DRAWINGS

FIG. 1 is an isometric view of one embodiment of a device with stacked PIC dies.

FIG. 2 is a cross-sectional view of one embodiment of the device of FIG. 1.

FIG. 3 is a cross-sectional view of one embodiment of the device of FIG. 1.

FIG. 4 is a cross-sectional view of one embodiment of the device of FIG. 1.

FIG. 5 is a cross-sectional view of one embodiment of the device of FIG. 1.

FIG. 6 is a cross-sectional view of one embodiment of the device of FIG. 1.

FIG. 7 is a simplified flow diagram of at least one embodiment of a method for manufacturing a device with stacked PIC dies.

FIG. 8 is a top view of a wafer and dies that may be included in a microelectronic assembly, in accordance with any of the embodiments disclosed herein.

FIG. 9 is a cross-sectional side view of an integrated circuit device that may be included in a microelectronic assembly, in accordance with any of the embodiments disclosed herein.

FIGS. 10A-10D are perspective views of example planar, gate-all-around, and stacked gate-all-around transistors.

FIG. 11 is a cross-sectional side view of an integrated circuit device assembly that may include a microelectronic assembly, in accordance with any of the embodiments disclosed herein.

FIG. 12 is a block diagram of an example electrical device that may include a microelectronic assembly, in accordance with any of the embodiments disclosed herein.

### DETAILED DESCRIPTION

In various embodiments disclosed herein, a device includes an electronic integrated circuit (EIC) die and several photonic integrated circuit (PIC) dies stacked on top of each other. Waveguides in the PIC dies are coupled to each other using an optical bridge, such as mirrors or lenses in glass, direct-write waveguides, or photonic wire bonding. The use of stacked PIC dies can both increase yield and reduce the footprint of the device.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that sends signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

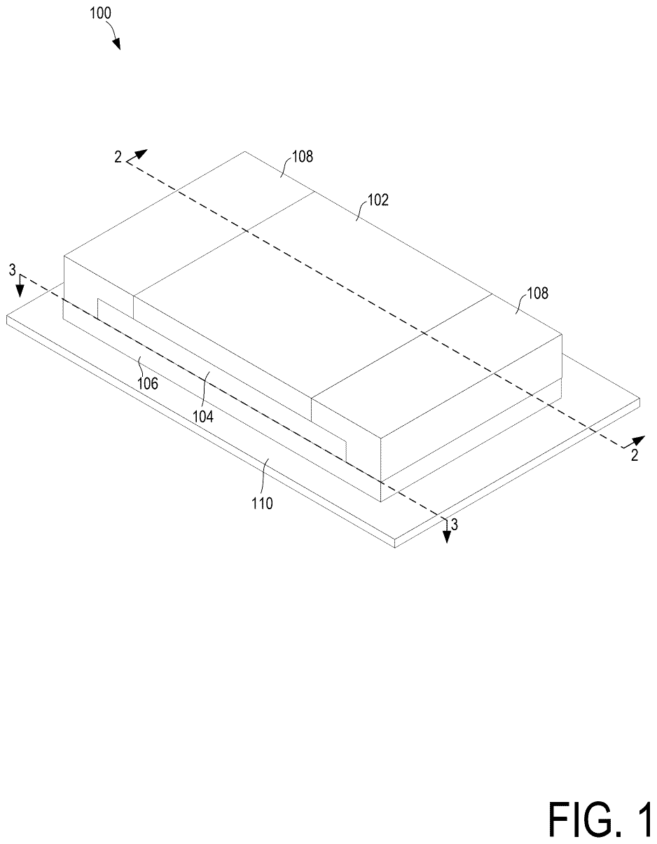

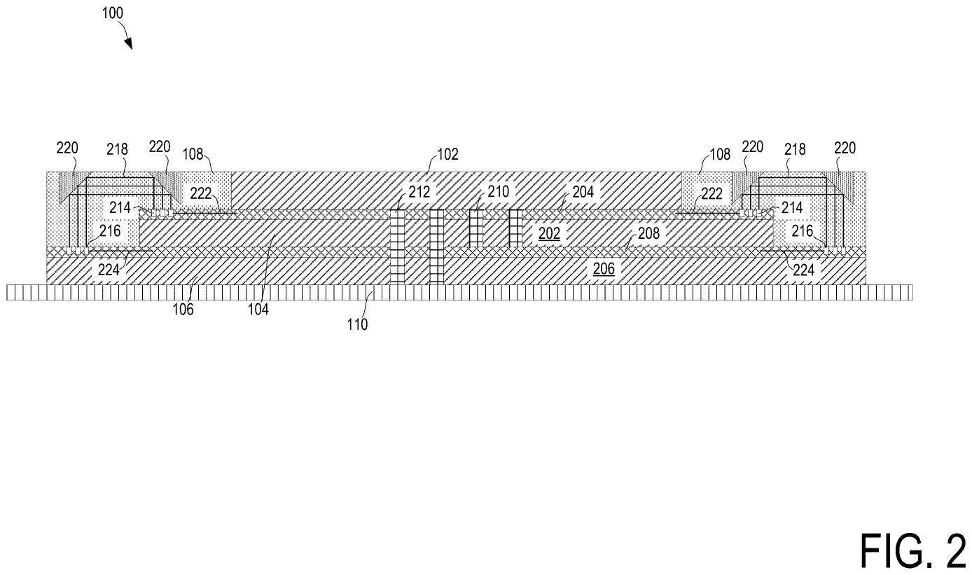

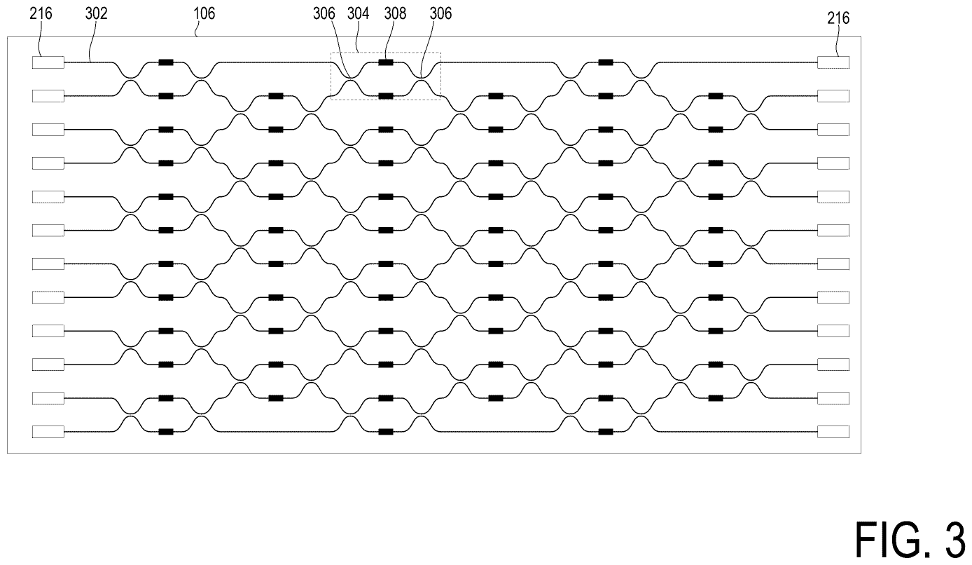

Referring now to FIGS. 1-3, in one embodiment, a device 100 includes an electrical integrated circuit (EIC) die 102 and two photonic integrated circuit (PIC) dies 104, 106 stacked on top of each other. FIG. 2 shows a cross-sectional side view of the device 100, and FIG. 3 shows a top view of one of the PIC dies 106. Optical bridges 108 couple waveguides in the upper PIC die 104 to the lower PIC die 106. The EIC die 102 and the PIC dies 104, 106 are supported on a circuit board 110.

The device 100 may be embodied as or otherwise include a system-on-a-chip (SoC), a processor, a memory, a graphics processor, an accelerator, an application-specific integrated circuit, a field-programmable gate array, a network router, a network switch, a network interface controller, a server computer, a mobile computing device, etc.

In the illustrative embodiment, stacking two or more PIC dies 104, 106 provides several advantages. The yield of each of several smaller PIC dies 104, 106 will generally be higher than the yield of a larger PIC die. Stacking the PIC dies 104, 106 can reduce the footprint required for the PIC dies 104, 106 or, alternatively, can increase the real estate of PIC dies 104, 106 in the same footprint. Additionally, in some embodiments, the PIC dies 104, 106 may be made using different technology nodes, may use different substrates, or may otherwise be incompatible with being made on a single PIC die.

As shown in FIG. 2, in one embodiment, the PIC die 104 has a substrate 202 and a photonic layer 204. Similarly, the PIC die 106 has a substrate 206 and a photonic layer 208. In the illustrative embodiment, some or all of the photonic components (i.e., waveguides, splitters, filters, lasers, etc.) are in the photonic layers 204, 208. Electrical vias 210, 212 can provide electrical connections between the PIC dies 104, 106 and/or the EIC die 102. The vias 210, 212 may provide input/output connections, power delivery, etc. In some embodiments, the vias 210, 212 may provide electrical connections between the circuit board 110 and the PIC dies 104, 106 and/or the EIC die 102.

In one embodiment, waveguides 222 in the PIC die 104 are coupled to vertical couplers 214, which direct light in the waveguides 222 vertically. The light forms beams 218 outside of the PIC die 104, which are reflected off of mirrors 220 towards the PIC die 106. Vertical couplers 216 in the PIC die 106 couple the beams 218 into waveguides 224 in the PIC die 106. The waveguides 222, 224 and other components of the PIC dies 104, 106 may operate at any suitable wavelength, such as 400-1,800 nanometers. In the illustrative embodiment, the operating wavelength has a center wavelength between 1260-1360 nanometers for an O-band signal or between 1530-1565 nanometers for a C-band signal. In other embodiments, the operating wavelength may be, e.g., an S-band signal or an L-band signal.

In order to for the light to be focused from the vertical couplers 214 to the vertical couplers 216 (or vice versa), any suitable technique may be used, such as forming lenses or mirrors in the photonic layers 204, 208 or substrates 202, 206, using curved mirrors 220 or lenses in the optical bridges 108, etc.

The EIC die 102 may be embodied as any suitable electrical integrated circuit. The EIC die 102 may be embodied as, form a part of, or include a processor, a system-on-a-chip (SoC), a memory, a graphics processor, an accelerator, an application-specific integrated circuit, a field-programmable gate array, and/or the like. In the illustrative embodiment, the EIC die 102 is electrically coupled to the PIC dies 104, 106 through vias 210, 212. Additionally or alternatively, the EIC die 102 may be electrically coupled to the PIC dies 104, 106 or other component such as the circuit board 110 in any other suitable manner, such as wire bonds, bumps, an embedded multi-die interconnect bridge (EMIB), etc.

The PIC dies 104, 106 may be made of any suitable material. In the illustrative embodiment, the substrates 202, 206 of the PIC dies 104, 106 is made of silicon. In other embodiments, the substrates 202, 2026 of the PIC dies 104, 106 may be made of any suitable material, such as glass, silicon oxide, polymer, etc. Similarly, the photonic layers 204, 208 may be made of or include any suitable material, such as silicon, silicon oxide, silicon nitride, polymer, glass, etc.

In the illustrative embodiment, the waveguides 222, 224 are silicon waveguides in a silicon oxide layer 204, 208. Each waveguide 222, 224 may have any suitable dimensions, such as a width and/or height of 0.1-10 micrometers. In the illustrative embodiment, each waveguide 222, 224 is square. In other embodiments, the waveguide 222, 224 may have a different shape, such as a rectangular shape. The PIC die 104 may include any suitable number of waveguides 222 coupled to waveguides 224 of the PIC die 106, such as 1-128 waveguides 222 or more. Of course, the PIC dies 104, 106 may include additional waveguides internally.

The PIC dies 104, 106 may include one or more lasers or other light sources, detectors, amplitude and/or phase modulators, filters, splitters, amplifiers, interferometers, microring resonators, gratings, squeezed or other quantum light sources, etc. In some embodiments, lights from off-die sources such as lasers may be provided to the PIC dies 104, 106. The PIC dies 104, 106 may perform any suitable function, such as converting optical signals to electrical signals or vice versa, matrix multiplication, quantum logic gates, optical compute gates, etc.

In FIG. 3, a top-down view of one embodiment of a PIC die 106 is shown. In the illustrative embodiment, the PIC die 106 includes an array of Mach-Zehnder interferometers 304. Vertical couplers 216 couple light into and out of waveguides 302. The vertical couplers 216 may be connected to another PIC die, such as the PIC die 104. The waveguides 302 of the PIC die 106 are provided as inputs to the array of Mach-Zehnder interferometers 304. Each Mach-Zehnder interferometer includes two splitters 306 and a phase shifter 308. In the illustrative embodiment, the phase shifters 308 are controlled by electrical signals from the EIC 102 through vias 210, 212. It should be appreciated that the embodiment shown in FIG. 3 is merely one possible embodiment of a PIC die 106, and other PIC dies 106 may include additional or fewer components than those shown in FIG. 3. In some embodiments, the PIC dies 104, 106 may include vertical couplers 214, 216 along any edge of the PIC dies 104, 106 as desired.

In the illustrative embodiment, the EIC die 102 and the PIC die 104 are bonded together using hybrid bonding. In other embodiments, other techniques may be used, such as using microbumps. The PIC dies 104, 106 may be bonded together in a similar manner.

The PIC dies 104, 106 and/or the EIC die 102 may be positioned using any suitable technique, such as by using a pick-and-place machine. The PIC dies 104, 106 and/or the EIC die 102 may include one or more fiducials, which may be used by a pick-and-place machine to place another PIC die 104, 106 and/or EIC die 102. The fiducials may be embodied as, e.g., a dot, a line, or other structure that indicates a location of a particular part of the PIC dies 104, 106 and/or the EIC die 102. The pick-and-place machine can align the PIC dies 104, 106 and/or the EIC die 102 with a high precision, such as a misalignment of less than 3-0.3 micrometers at 3 sigma.

The optical bridge 108 may be made of any suitable material, such as glass, silicon, silicon oxide, polymer, etc. The mirrors 220 may be made from any suitable material, such as aluminum, silver, an interference film, etc. The device 100 may include any suitable number of optical bridges 108. For example, in one embodiment, one optical bridge 108 may provide all connections between the PIC dies 104, 106. In other embodiments, several optical bridges 108 may be used to provide the connections between the PIC dies 104, 106. The optical bridges 108 may be located in any suitable position, such as along any edge of the PIC dies 104, 106. In some embodiments, a channel may be defined in a PIC die 104, 106, and part of one or more optical bridges 108 may be positioned in the channel, potentially aligned to one or more waveguides.

The illustrative circuit board 110 may be made from ceramic, glass, and/or organic-based materials with fiberglass and resin, such as FR-4. The circuit board 110 may have any suitable length or width, such as 10-500 millimeters. The circuit board 110 may have any suitable thickness, such as 0.2-5 millimeters. The circuit board 110 may support additional components besides the PIC dies 104, 106 and EIC die 102, such as additional EIC dies or PIC dies, a processor unit, a memory device, an accelerator device, etc.

It should be appreciated that the configuration shown in FIG. 1 with one EIC die 102 stacked on two PIC dies 104, 106 is merely one possible embodiment. In some embodiments, more or fewer EIC dies and/or PIC dies may be included. For example, in some embodiments, the PIC die 104 may have two EIC dies 102 on top of it. In another example, two PIC dies may be below the EIC die 102. In some embodiments, one or more EIC dies 102 may be between two PIC dies 104, 106. In general, any suitable arrangement of stacking EIC dies and/or PIC dies may be used. For example, the device 100 may include, e.g., 2-10 PIC dies and/or EIC dies stacked on top of each other. In some embodiments, one optical bridge 108 may connect more than two PIC dies. For example, one optical bridge 108 may optically couple a first PIC die to a second PIC die, a second PIC die to a third PIC die, and the first PIC die to the third PIC die. Additionally or alternatively, one optical bridge 108 may be used to optically couple the first PIC die to the second PIC die, and a second optical bridge 108 may be used to optically couple the second PIC die to the third PIC die.

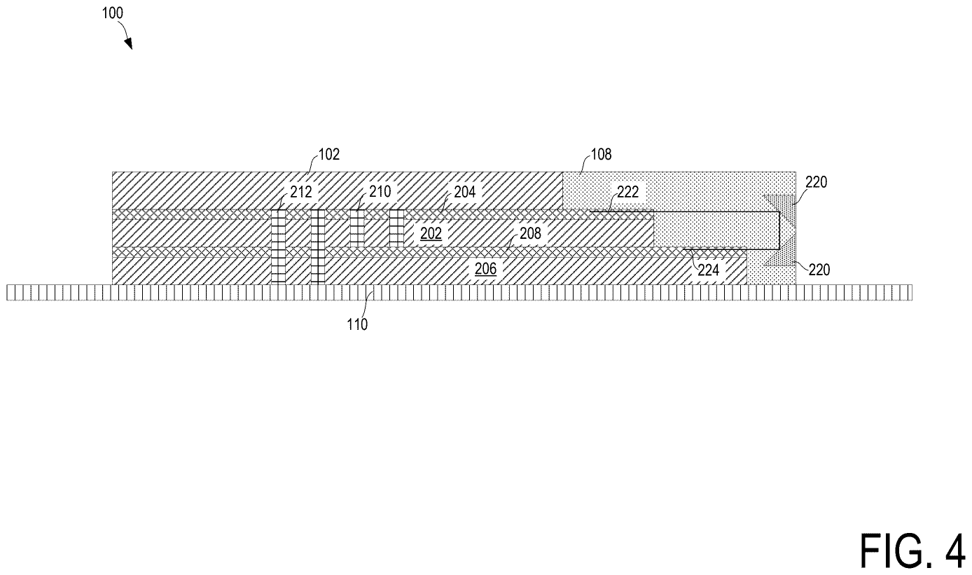

Referring now to FIG. 4, in one embodiment, a device 100 includes PIC dies 104, 106 with waveguides 222, 224 that extend to an edge of the PIC dies 104, 106. In such an embodiment, the optical bridge 108 may include mirrors 220 that reflect the edge-emitted light from the waveguides 222 to the waveguides 224 (or vice versa). Similar to the embodiment described above in regard to FIGS. 1 and 2, in order to for the light to be focused from the waveguides 222 to the waveguides 224, any suitable technique may be used, such as forming lenses or mirrors in the photonic layers 204, 208 or substrates 202, 206, using curved mirrors 220 or lenses in the optical bridges 108, etc.

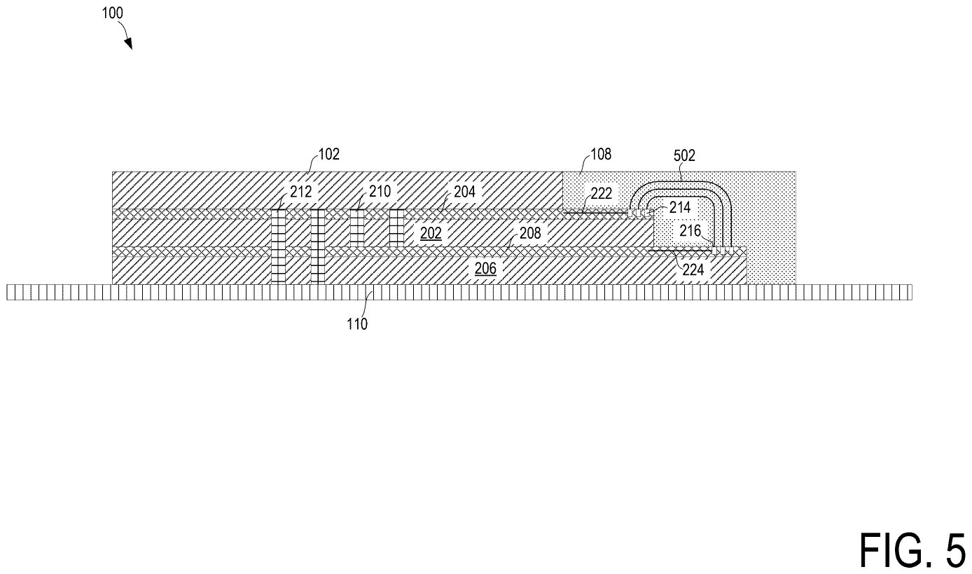

Referring now to FIG. 5, in one embodiment, a device 100 includes an optical bridge 108 with direct-write waveguides 502 connecting the light from the vertical couplers 214 to the vertical couplers 216. Any suitable direct-write approach may be used, such as using femtosecond lasers to write waveguides in glass, crystals, or polymers.

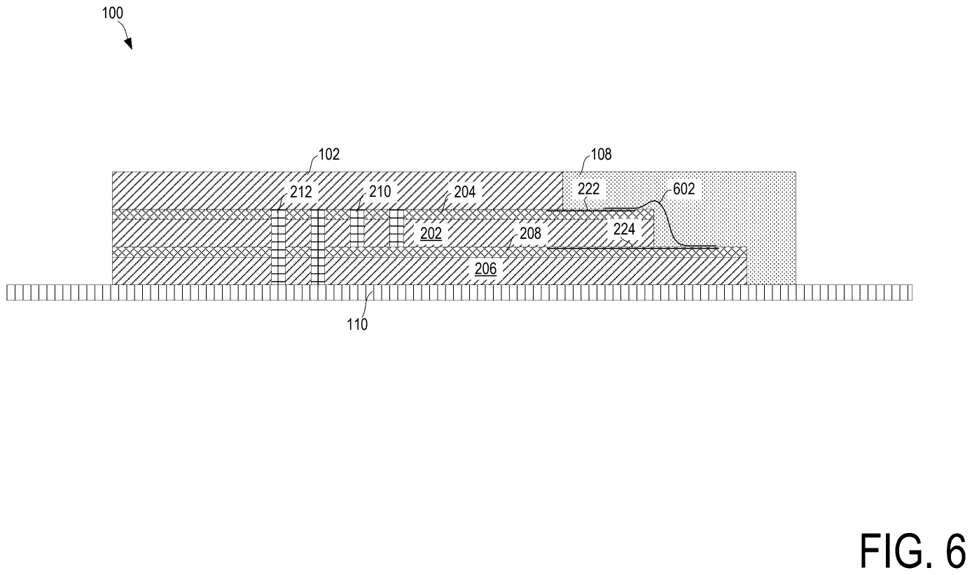

Referring now to FIG. 6, in one embodiment, a device 100 includes an optical bridge 108 with photonic wire bonds 602 connecting the waveguides 222 to the waveguides 224. In the illustrative embodiment, light from the waveguides 222 is evanescently coupled to the photonic wire bonds 602, and then light in the photonic wire bonds is evanescently coupled to the waveguides 224.

It should be appreciated that the possible approaches described above for optically coupling the PIC dies 104, 106 together are merely some possible approaches, and other approaches or combinations may be used. For example, in one embodiment, direct-write waveguides may be used to create waveguides that are evanescently coupled to the waveguides 222 and/or the waveguides 224. In another example, photonic wire bonds 602 may couple to edge-emitting waveguides 222, 224 and/or the vertical couplers 214, 216. In general, any suitable coupling technique or combination of techniques may be used to optically couple the PIC dies 104, 106.

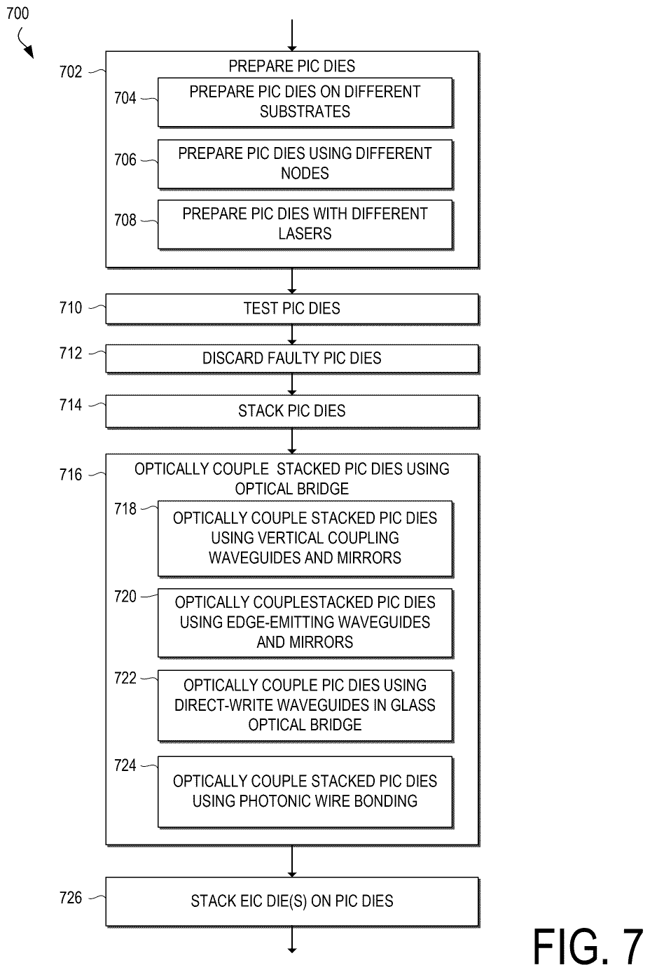

Referring now to FIG. 7, in one embodiment, a flowchart for a method 700 for creating the device 100 is shown. The method 700 may be executed by a technician and/or by one or more automated machines. In some embodiments, one or more machines may be programmed to do some or all of the steps of the method 700. Such a machine may include, e.g., a memory, a processor, data storage, etc. The memory and/or data storage may store instructions that, when executed by the machine, causes the machine to perform some or all of the steps of the method 700. The method 700 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, thermal treatments, flip chip, layer transfer, magnetron sputter deposition, pulsed laser deposition, pick-and-place, etc. It should be appreciated that the method 700 is merely one embodiment of a method to create the device 100, and other methods may be used to create the device 100. In some embodiments, steps of the method 700 may be performed in a different order than that shown in the flowchart.

The method 700 begins in block 702, in which PIC dies, such as PIC dies 104, 106, are prepared. In block 704, PIC dies may be prepared on different substrates. In block 706, PIC dies may be prepared using different nodes. In block 708, PIC dies may be prepared with different lasers.

In block 710, the PIC dies are tested. In block 712, faulty PIC dies are discarded. In some embodiments, the PIC dies may be relatively small, so only a relatively small component may be discarded if there is a fault.

In block 714, the PIC dies are stacked on top of each other. The PIC dies may be stacked using any suitable technique, such as copper bumps or hybrid bonding.

In block 716, the stacked PIC dies are optically coupled using an optical bridge 108. In block 718, the stacked PIC dies may be optically coupled using vertical coupling waveguides and mirrors 220, as shown in FIG. 2. In block 720, the stacked PIC dies may be optically coupled using edge-emitting waveguides 222, 224 and mirrors 220, as shown in FIG. 4. In block 722, the stacked PIC dies may be optically coupled using direct-write waveguides 502 in a glass optical bridge 108, as shown in FIG. 6. In block 724, the stacked PIC dies may be optically coupled using photonic wire bonds 602, as shown in FIG. 6.

In block 726, one or more EIC dies 102 may be stacked on the PIC dies. Additional packaging steps may then be performed, such as wire bonding connections from the circuit board 110 to the EIC dies 102.

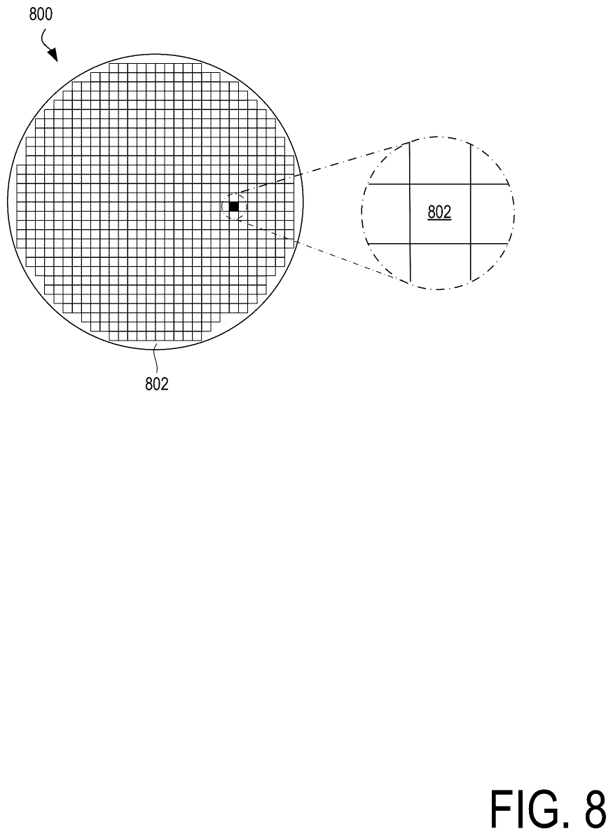

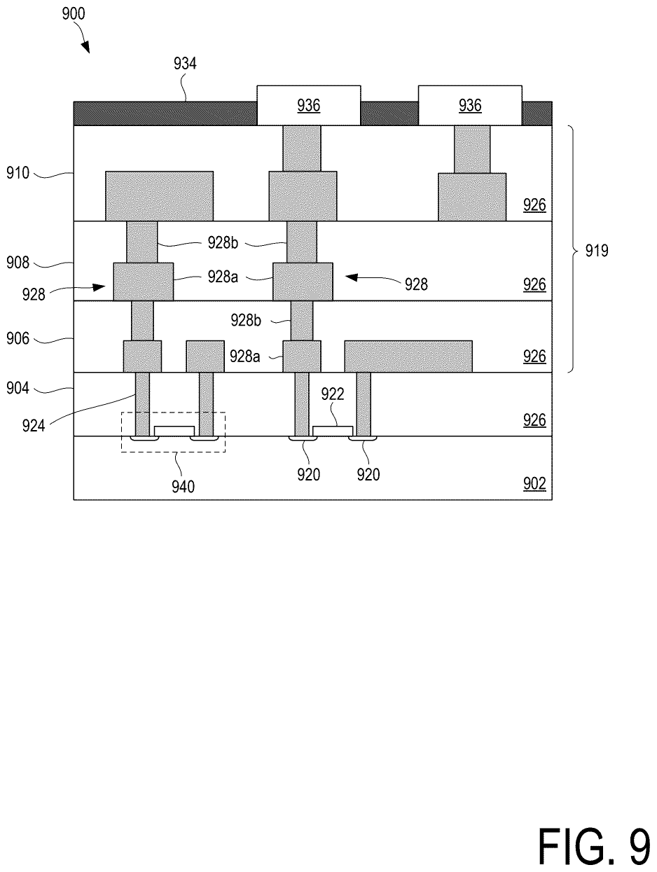

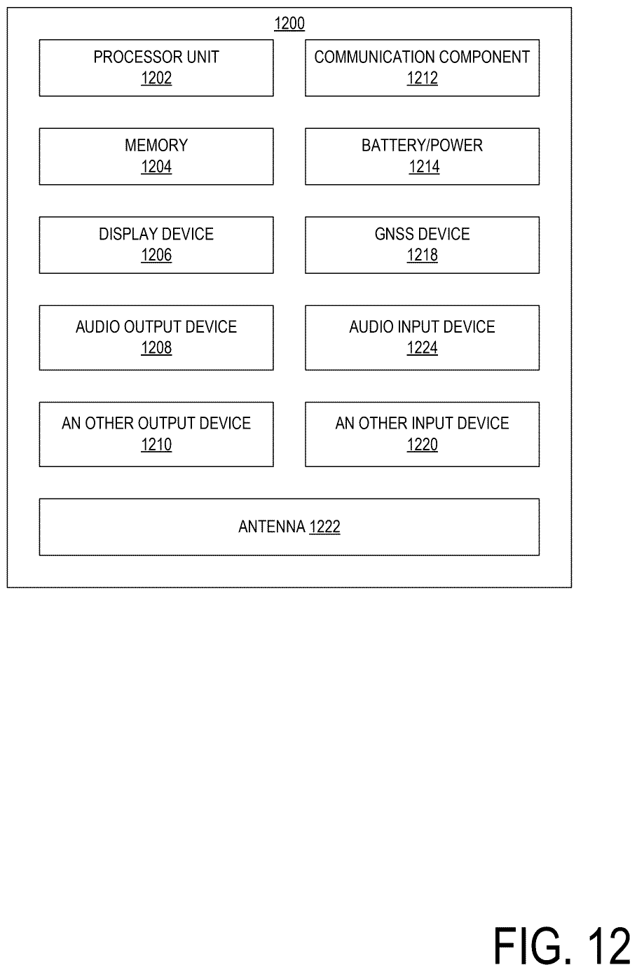

FIG. 8 is a top view of a wafer 800 and dies 802 that may be included in any of the devices 100 disclosed herein (e.g., as any suitable ones of the dies 102, 104, 106). The wafer 800 may be composed of semiconductor material and may include one or more dies 802 having integrated circuit structures formed on a surface of the wafer 800. The individual dies 802 may be a repeating unit of an integrated circuit product that includes any suitable integrated circuit. After the fabrication of the semiconductor product is complete, the wafer 800 may undergo a singulation process in which the dies 802 are separated from one another to provide discrete “chips” of the integrated circuit product. The die 802 may be any of the dies 114 102, 104, 106 herein. The die 802 may include one or more transistors (e.g., some of the transistors 940 of FIG. 9, discussed below), supporting circuitry to route electrical signals to the transistors, passive components (e.g., signal traces, resistors, capacitors, or inductors), and/or any other integrated circuit components. In some embodiments, the wafer 800 or the die 802 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 802. For example, a memory array formed by multiple memory devices may be formed on a same die 802 as a processor unit (e.g., the processor unit 1202 of FIG. 12) or other logic that is configured to store information in the memory devices or execute instructions stored in the memory array. Various ones of the devices 100 disclosed herein may be manufactured using a die-to-wafer assembly technique in which some dies 102, 104, 106 are attached to a wafer 800 that include others of the dies 102, 104, 106, and the wafer 800 is subsequently singulated.

FIG. 9 is a cross-sectional side view of an integrated circuit device 900 that may be included in any of the devices 100 disclosed herein (e.g., in any of the dies 102, 104, 106). One or more of the integrated circuit devices 900 may be included in one or more dies 802 (FIG. 8). The integrated circuit device 900 may be formed on a die substrate 902 (e.g., the wafer 800 of FIG. 8) and may be included in a die (e.g., the die 802 of FIG. 8). The die substrate 902 may be a semiconductor substrate composed of semiconductor material systems including, for example, n-type or p-type materials systems (or a combination of both). The die substrate 902 may include, for example, a crystalline substrate formed using a bulk silicon or a silicon-on-insulator (SOI) substructure. In some embodiments, the die substrate 902 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 902. Although a few examples of materials from which the die substrate 902 may be formed are described here, any material that may serve as a foundation for an integrated circuit device 900 may be used. The die substrate 902 may be part of a singulated die (e.g., the dies 802 of FIG. 8) or a wafer (e.g., the wafer 800 of FIG. 8).

The integrated circuit device 900 may include one or more device layers 904 disposed on the die substrate 902. The device layer 904 may include features of one or more transistors 940 (e.g., metal oxide semiconductor field-effect transistors (MOSFETs)) formed on the die substrate 902. The transistors 940 may include, for example, one or more source and/or drain (S/D) regions 920, a gate 922 to control current flow between the S/D regions 920, and one or more S/D contacts 924 to route electrical signals to/from the S/D regions 920. The transistors 940 may include additional features not depicted for the sake of clarity, such as device isolation regions, gate contacts, and the like. The transistors 940 are not limited to the type and configuration depicted in FIG. 9 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

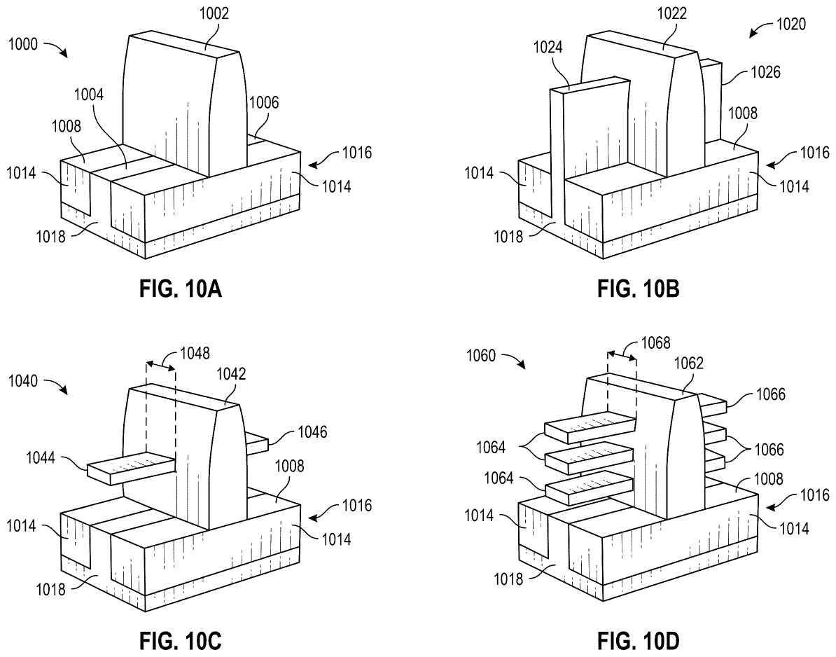

FIGS. 10A-10D are simplified perspective views of example planar, FinFET, gate-all-around, and stacked gate-all-around transistors. The transistors illustrated in FIGS. 10A-10D are formed on a substrate 1016 having a surface 1008. Isolation regions 1014 separate the source and drain regions of the transistors from other transistors and from a bulk region 1018 of the substrate 1016.

FIG. 10A is a perspective view of an example planar transistor 1000 comprising a gate 1002 that controls current flow between a source region 1004 and a drain region 1006. The transistor 1000 is planar in that the source region 1004 and the drain region 1006 are planar with respect to the substrate surface 1008.

FIG. 10B is a perspective view of an example FinFET transistor 1020 comprising a gate 1022 that controls current flow between a source region 1024 and a drain region 1026. The transistor 1020 is non-planar in that the source region 1024 and the drain region 1026 comprise “fins” that extend upwards from the substrate surface 1028. As the gate 1022 encompasses three sides of the semiconductor fin that extends from the source region 1024 to the drain region 1026, the transistor 1020 can be considered a tri-gate transistor. FIG. 10B illustrates one S/D fin extending through the gate 1022, but multiple S/D fins can extend through the gate of a FinFET transistor.

FIG. 10C is a perspective view of a gate-all-around (GAA) transistor 1040 comprising a gate 1042 that controls current flow between a source region 1044 and a drain region 1046. The transistor 1040 is non-planar in that the source region 1044 and the drain region 1046 are elevated from the substrate surface 1028.

FIG. 10D is a perspective view of a GAA transistor 1060 comprising a gate 1062 that controls current flow between multiple elevated source regions 1064 and multiple elevated drain regions 1066. The transistor 1060 is a stacked GAA transistor as the gate controls the flow of current between multiple elevated S/D regions stacked on top of each other. The transistors 1040 and 1060 are considered gate-all-around transistors as the gates encompass all sides of the semiconductor portions that extends from the source regions to the drain regions. The transistors 1040 and 1060 can alternatively be referred to as nanowire, nanosheet, or nanoribbon transistors depending on the width (e.g., widths 1048 and 1068 of transistors 1040 and 1060, respectively) of the semiconductor portions extending through the gate.

Returning to FIG. 9, a transistor 940 may include a gate 922 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 940 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 940 along the source-channel-drain direction, the gate electrode may consist of a U-shaped structure that includes a bottom portion substantially parallel to the surface of the die substrate 902 and two sidewall portions that are substantially perpendicular to the top surface of the die substrate 902. In other embodiments, at least one of the metal layers that form the gate electrode may simply be a planar layer that is substantially parallel to the top surface of the die substrate 902 and does not include sidewall portions substantially perpendicular to the top surface of the die substrate 902. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 920 may be formed within the die substrate 902 adjacent to the gate 922 of individual transistors 940. The S/D regions 920 may be formed using an implantation/diffusion process or an etching/deposition process, for example. In the former process, dopants such as boron, aluminum, antimony, phosphorous, or arsenic may be ion-implanted into the die substrate 902 to form the S/D regions 920. An annealing process that activates the dopants and causes them to diffuse farther into the die substrate 902 may follow the ion-implantation process. In the latter process, the die substrate 902 may first be etched to form recesses at the locations of the S/D regions 920. An epitaxial deposition process may then be carried out to fill the recesses with material that is used to fabricate the S/D regions 920. In some implementations, the S/D regions 920 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 920 may be formed using one or more alternate semiconductor materials such as germanium or a group III-V material or alloy. In further embodiments, one or more layers of metal and/or metal alloys may be used to form the S/D regions 920.

Electrical signals, such as power and/or input/output (I/O) signals, may be routed to and/or from the devices (e.g., transistors 940) of the device layer 904 through one or more interconnect layers disposed on the device layer 904 (illustrated in FIG. 9 as interconnect layers 906-910). For example, electrically conductive features of the device layer 904 (e.g., the gate 922 and the S/D contacts 924) may be electrically coupled with the interconnect structures 928 of the interconnect layers 906-910. The one or more interconnect layers 906-910 may form a metallization stack (also referred to as an “ILD stack”) 919 of the integrated circuit device 900.

The interconnect structures 928 may be arranged within the interconnect layers 906-910 to route electrical signals according to a wide variety of designs; in particular, the arrangement is not limited to the particular configuration of interconnect structures 928 depicted in FIG. 9. Although a particular number of interconnect layers 906-910 is depicted in FIG. 9, embodiments of the present disclosure include integrated circuit devices having more or fewer interconnect layers than depicted.

In some embodiments, the interconnect structures 928 may include lines 928a and/or vias 928b filled with an electrically conductive material such as a metal. The lines 928a may be arranged to route electrical signals in a direction of a plane that is substantially parallel with a surface of the die substrate 902 upon which the device layer 904 is formed. For example, the lines 928a may route electrical signals in a direction in and out of the page and/or in a direction across the page. The vias 928b may be arranged to route electrical signals in a direction of a plane that is substantially perpendicular to the surface of the die substrate 902 upon which the device layer 904 is formed. In some embodiments, the vias 928b may electrically couple lines 928a of different interconnect layers 906-910 together.

The interconnect layers 906-910 may include a dielectric material 926 disposed between the interconnect structures 928, as shown in FIG. 9. In some embodiments, dielectric material 926 disposed between the interconnect structures 928 in different ones of the interconnect layers 906-910 may have different compositions; in other embodiments, the composition of the dielectric material 926 between different interconnect layers 906-910 may be the same. The device layer 904 may include a dielectric material 926 disposed between the transistors 940 and a bottom layer of the metallization stack as well. The dielectric material 926 included in the device layer 904 may have a different composition than the dielectric material 926 included in the interconnect layers 906-910; in other embodiments, the composition of the dielectric material 926 in the device layer 904 may be the same as a dielectric material 926 included in any one of the interconnect layers 906-910.

A first interconnect layer 906 (referred to as Metal 1 or “M1”) may be formed directly on the device layer 904. In some embodiments, the first interconnect layer 906 may include lines 928a and/or vias 928b, as shown. The lines 928a of the first interconnect layer 906 may be coupled with contacts (e.g., the S/D contacts 924) of the device layer 904. The vias 928b of the first interconnect layer 906 may be coupled with the lines 928a of a second interconnect layer 908.

The second interconnect layer 908 (referred to as Metal 2 or “M2”) may be formed directly on the first interconnect layer 906. In some embodiments, the second interconnect layer 908 may include via 928b to couple the lines 928 of the second interconnect layer 908 with the lines 928a of a third interconnect layer 910. Although the lines 928a and the vias 928b are structurally delineated with a line within individual interconnect layers for the sake of clarity, the lines 928a and the vias 928b may be structurally and/or materially contiguous (e.g., simultaneously filled during a dual-damascene process) in some embodiments.

The third interconnect layer 910 (referred to as Metal 3 or “M3”) (and additional interconnect layers, as desired) may be formed in succession on the second interconnect layer 908 according to similar techniques and configurations described in connection with the second interconnect layer 908 or the first interconnect layer 906. In some embodiments, the interconnect layers that are “higher up” in the metallization stack 919 in the integrated circuit device 900 (i.e., farther away from the device layer 904) may be thicker that the interconnect layers that are lower in the metallization stack 919, with lines 928a and vias 928b in the higher interconnect layers being thicker than those in the lower interconnect layers.

The integrated circuit device 900 may include a solder resist material 934 (e.g., polyimide or similar material) and one or more conductive contacts 936 formed on the interconnect layers 906-910. In FIG. 9, the conductive contacts 936 are illustrated as taking the form of bond pads. The conductive contacts 936 may be electrically coupled with the interconnect structures 928 and configured to route the electrical signals of the transistor(s) 940 to external devices. For example, solder bonds may be formed on the one or more conductive contacts 936 to mechanically and/or electrically couple an integrated circuit die including the integrated circuit device 900 with another component (e.g., a printed circuit board). The integrated circuit device 900 may include additional or alternate structures to route the electrical signals from the interconnect layers 906-910; for example, the conductive contacts 936 may include other analogous features (e.g., posts) that route the electrical signals to external components.

In some embodiments in which the integrated circuit device 900 is a double-sided die, the integrated circuit device 900 may include another metallization stack (not shown) on the opposite side of the device layer(s) 904. This metallization stack may include multiple interconnect layers as discussed above with reference to the interconnect layers 906-910, to provide conductive pathways (e.g., including conductive lines and vias) between the device layer(s) 904 and additional conductive contacts (not shown) on the opposite side of the integrated circuit device 900 from the conductive contacts 936.

In other embodiments in which the integrated circuit device 900 is a double-sided die, the integrated circuit device 900 may include one or more through silicon vias (TSVs) through the die substrate 902; these TSVs may make contact with the device layer(s) 904, and may provide conductive pathways between the device layer(s) 904 and additional conductive contacts (not shown) on the opposite side of the integrated circuit device 900 from the conductive contacts 936. In some embodiments, TSVs extending through the substrate can be used for routing power and ground signals from conductive contacts on the opposite side of the integrated circuit device 900 from the conductive contacts 936 to the transistors 940 and any other components integrated into the die 900, and the metallization stack 919 can be used to route I/O signals from the conductive contacts 936 to transistors 940 and any other components integrated into the die 900.

Multiple integrated circuit devices 900 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

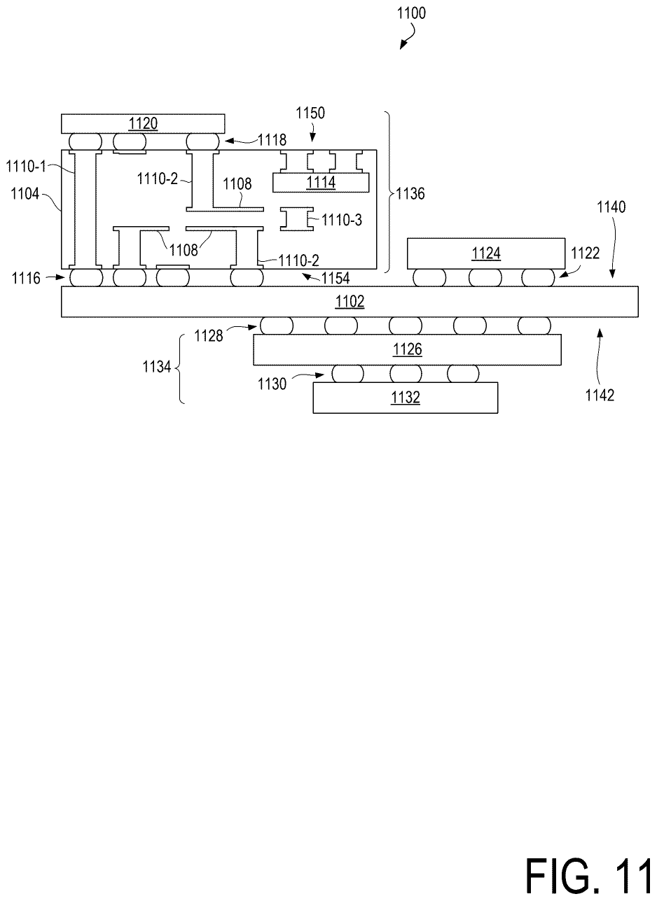

FIG. 11 is a cross-sectional side view of an integrated circuit device assembly 1100 that may be included in any of the devices 100 disclosed herein. In some embodiments, the integrated circuit device assembly 1100 may be a device 100. The integrated circuit device assembly 1100 includes a number of components disposed on a circuit board 1102 (which may be a motherboard, system board, mainboard, etc.). The integrated circuit device assembly 1100 includes components disposed on a first face 1140 of the circuit board 1102 and an opposing second face 1142 of the circuit board 1102; generally, components may be disposed on one or both faces 1140 and 1142. Any of the integrated circuit components discussed below with reference to the integrated circuit device assembly 1100 may take the form of any suitable ones of the embodiments of the device 100 disclosed herein.

In some embodiments, the circuit board 1102 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1102. In other embodiments, the circuit board 1102 may be a non-PCB substrate. In some embodiments the circuit board 1102 may be, for example, the circuit board 110. The integrated circuit device assembly 1100 illustrated in FIG. 11 includes a package-on-interposer structure 1136 coupled to the first face 1140 of the circuit board 1102 by coupling components 1116. The coupling components 1116 may electrically and mechanically couple the package-on-interposer structure 1136 to the circuit board 1102, and may include solder balls (as shown in FIG. 11), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1136 may include an integrated circuit component 1120 coupled to an interposer 1104 by coupling components 1118. The coupling components 1118 may take any suitable form for the application, such as the forms discussed above with reference to the coupling components 1116. Although a single integrated circuit component 1120 is shown in FIG. 11, multiple integrated circuit components may be coupled to the interposer 1104; indeed, additional interposers may be coupled to the interposer 1104. The interposer 1104 may provide an intervening substrate used to bridge the circuit board 1102 and the integrated circuit component 1120.

The integrated circuit component 1120 may be a packaged or unpacked integrated circuit product that includes one or more integrated circuit dies (e.g., the die 802 of FIG. 8, the integrated circuit device 900 of FIG. 9) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1120, a single monolithic integrated circuit die comprises solder bumps attached to contacts on the die. The solder bumps allow the die to be directly attached to the interposer 1104. The integrated circuit component 1120 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1120 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1120 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1120 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1104 may spread connections to a wider pitch or reroute a connection to a different connection. For example, the interposer 1104 may couple the integrated circuit component 1120 to a set of ball grid array (BGA) conductive contacts of the coupling components 1116 for coupling to the circuit board 1102. In the embodiment illustrated in FIG. 11, the integrated circuit component 1120 and the circuit board 1102 are attached to opposing sides of the interposer 1104; in other embodiments, the integrated circuit component 1120 and the circuit board 1102 may be attached to a same side of the interposer 1104. In some embodiments, three or more components may be interconnected by way of the interposer 1104.

In some embodiments, the interposer 1104 may be formed as a PCB, including multiple metal layers separated from one another by layers of dielectric material and interconnected by electrically conductive vias. In some embodiments, the interposer 1104 may be formed of an epoxy resin, a fiberglass-reinforced epoxy resin, an epoxy resin with inorganic fillers, a ceramic material, or a polymer material such as polyimide. In some embodiments, the interposer 1104 may be formed of alternate rigid or flexible materials that may include the same materials described above for use in a semiconductor substrate, such as silicon, germanium, and other group III-V and group IV materials. The interposer 1104 may include metal interconnects 1108 and vias 1110, including but not limited to through hole vias 1110-1 (that extend from a first face 1150 of the interposer 1104 to a second face 1154 of the interposer 1104), blind vias 1110-2 (that extend from the first or second faces 1150 or 1154 of the interposer 1104 to an internal metal layer), and buried vias 1110-3 (that connect internal metal layers).

In some embodiments, the interposer 1104 can comprise a silicon interposer. Through silicon vias (TSV) extending through the silicon interposer can connect connections on a first face of a silicon interposer to an opposing second face of the silicon interposer. In some embodiments, an interposer 1104 comprising a silicon interposer can further comprise one or more routing layers to route connections on a first face of the interposer 1104 to an opposing second face of the interposer 1104.

The interposer 1104 may further include embedded devices 1114, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1104. The package-on-interposer structure 1136 may take the form of any of the package-on-interposer structures known in the art. In embodiments where the interposer is a non-printed circuit board

The integrated circuit device assembly 1100 may include an integrated circuit component 1124 coupled to the first face 1140 of the circuit board 1102 by coupling components 1122. The coupling components 1122 may take the form of any of the embodiments discussed above with reference to the coupling components 1116, and the integrated circuit component 1124 may take the form of any of the embodiments discussed above with reference to the integrated circuit component 1120.

The integrated circuit device assembly 1100 illustrated in FIG. 11 includes a package-on-package structure 1134 coupled to the second face 1142 of the circuit board 1102 by coupling components 1128. The package-on-package structure 1134 may include an integrated circuit component 1126 and an integrated circuit component 1132 coupled together by coupling components 1130 such that the integrated circuit component 1126 is disposed between the circuit board 1102 and the integrated circuit component 1132. The coupling components 1128 and 1130 may take the form of any of the embodiments of the coupling components 1116 discussed above, and the integrated circuit components 1126 and 1132 may take the form of any of the embodiments of the integrated circuit component 1120 discussed above. The package-on-package structure 1134 may be configured in accordance with any of the package-on-package structures known in the art.

FIG. 12 is a block diagram of an example electrical device 1200 that may include one or more of the devices 100 disclosed herein. For example, any suitable ones of the components of the electrical device 1200 may include one or more of the integrated circuit device assemblies 1100, integrated circuit components 1120, integrated circuit devices 900, or integrated circuit dies 802 disclosed herein, and may be arranged in any of the devices 100 disclosed herein. A number of components are illustrated in FIG. 12 as included in the electrical device 1200, but any one or more of these components may be omitted or duplicated, as suitable for the application. In some embodiments, some or all of the components included in the electrical device 1200 may be attached to one or more motherboards mainboards, or system boards. In some embodiments, one or more of these components are fabricated onto a single system-on-a-chip (SoC) die.

Additionally, in various embodiments, the electrical device 1200 may not include one or more of the components illustrated in FIG. 12, but the electrical device 1200 may include interface circuitry for coupling to the one or more components. For example, the electrical device 1200 may not include a display device 1206, but may include display device interface circuitry (e.g., a connector and driver circuitry) to which a display device 1206 may be coupled. In another set of examples, the electrical device 1200 may not include an audio input device 1224 or an audio output device 1208, but may include audio input or output device interface circuitry (e.g., connectors and supporting circuitry) to which an audio input device 1224 or audio output device 1208 may be coupled.

The electrical device 1200 may include one or more processor units 1202 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1202 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1200 may include a memory 1204, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1204 may include memory that is located on the same integrated circuit die as the processor unit 1202. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1200 can comprise one or more processor units 1202 that are heterogeneous or asymmetric to another processor unit 1202 in the electrical device 1200. There can be a variety of differences between the processing units 1202 in a system in terms of a spectrum of metrics of merit including architectural, microarchitectural, thermal, power consumption characteristics, and the like. These differences can effectively manifest themselves as asymmetry and heterogeneity among the processor units 1202 in the electrical device 1200.

In some embodiments, the electrical device 1200 may include a communication component 1212 (e.g., one or more communication components). For example, the communication component 1212 can manage wireless communications for the transfer of data to and from the electrical device 1200. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1212 may operate in accordance with other wireless protocols in other embodiments. The electrical device 1200 may include an antenna 1222 to facilitate wireless communications and/or to receive other wireless communications (such as AM or FM radio transmissions).

In some embodiments, the communication component 1212 may manage wired communications, such as electrical, optical, or any other suitable communication protocols (e.g., IEEE 802.3 Ethernet standards). As noted above, the communication component 1212 may include multiple communication components. For instance, a first communication component 1212 may be dedicated to shorter-range wireless communications such as Wi-Fi or Bluetooth, and a second communication component 1212 may be dedicated to longer-range wireless communications such as global positioning system (GPS), EDGE, GPRS, CDMA, WiMAX, LTE, EV-DO, or others. In some embodiments, a first communication component 1212 may be dedicated to wireless communications, and a second communication component 1212 may be dedicated to wired communications.

The electrical device 1200 may include battery/power circuitry 1214. The battery/power circuitry 1214 may include one or more energy storage devices (e.g., batteries or capacitors) and/or circuitry for coupling components of the electrical device 1200 to an energy source separate from the electrical device 1200 (e.g., AC line power).

The electrical device 1200 may include a display device 1206 (or corresponding interface circuitry, as discussed above). The display device 1206 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1200 may include an audio output device 1208 (or corresponding interface circuitry, as discussed above). The audio output device 1208 may include any embedded or wired or wirelessly connected external device that generates an audible indicator, such speakers, headsets, or earbuds.

The electrical device 1200 may include an audio input device 1224 (or corresponding interface circuitry, as discussed above). The audio input device 1224 may include any embedded or wired or wirelessly connected device that generates a signal representative of a sound, such as microphones, microphone arrays, or digital instruments (e.g., instruments having a musical instrument digital interface (MIDI) output). The electrical device 1200 may include a Global Navigation Satellite System (GNSS) device 1218 (or corresponding interface circuitry, as discussed above), such as a Global Positioning System (GPS) device. The GNSS device 1218 may be in communication with a satellite-based system and may determine a geolocation of the electrical device 1200 based on information received from one or more GNSS satellites, as known in the art.

The electrical device 1200 may include an other output device 1210 (or corresponding interface circuitry, as discussed above). Examples of the other output device 1210 may include an audio codec, a video codec, a printer, a wired or wireless transmitter for providing information to other devices, or an additional storage device.

The electrical device 1200 may include an other input device 1220 (or corresponding interface circuitry, as discussed above). Examples of the other input device 1220 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1200 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1200 may be any other electronic device that processes data. In some embodiments, the electrical device 1200 may comprise multiple discrete physical components. Given the range of devices that the electrical device 1200 can be manifested as in various embodiments, in some embodiments, the electrical device 1200 can be referred to as a computing device or a computing system.

### Examples

Illustrative examples of the technologies disclosed herein are provided below. An embodiment of the technologies may include any one or more, and any combination of, the examples described below.
Example 1 includes a device comprising a first photonic integrated circuit (PIC) die, wherein a first plurality of waveguides are defined in the first PIC die; and a second PIC die stacked on the first PIC die, wherein a second plurality of waveguides are defined in the second PIC die, wherein individual waveguides of the first plurality of waveguides are optically coupled to individual waveguides of the second plurality of waveguides.
Example 2 includes the subject matter of Example 1, and further including an optical bridge, wherein the optical bridge optically couples the first plurality of waveguides to the second plurality of waveguides.
Example 3 includes the subject matter of any of Examples 1 and 2, and wherein the optical bridge comprises one or more mirrors, wherein the one or more mirrors direct beams from the first plurality of waveguides to the second plurality of waveguides.
Example 4 includes the subject matter of any of Examples 1-3, and wherein the optical bridge comprises a plurality of direct-write waveguides, wherein the plurality of direct-write waveguides guide light from the first plurality of waveguides to the second plurality of waveguides.
Example 5 includes the subject matter of any of Examples 1-4, and wherein the first PIC die comprises a first plurality of vertical couplers, wherein individual vertical couplers of the first plurality of vertical couplers are to couple light from individual waveguides of the first plurality of waveguides out of a surface of the first PIC die into individual direct-write waveguides of the plurality of direct-write waveguides, wherein the second PIC die comprises a second plurality of vertical couplers, wherein individual vertical couplers of the second plurality of vertical couplers are to couple light from individual waveguides of the second plurality of waveguides out of a surface of the second PIC die into individual direct-write waveguides of the plurality of direct-write waveguides.
Example 6 includes the subject matter of any of Examples 1-5, and wherein the optical bridge comprises a plurality of photonic wire bonds, wherein the plurality of photonic wire bonds guide light from the first plurality of waveguides to the second plurality of waveguides.
Example 7 includes the subject matter of any of Examples 1-6, and wherein individual photonic wire bonds of the plurality of photonic wire bonds are evanescently coupled to individual waveguides of the first plurality of waveguides and evanescently coupled to individual waveguides of the second plurality of waveguides.
Example 8 includes the subject matter of any of Examples 1-7, and wherein the device comprises at least four PIC dies stacked on top of each other, wherein the at least four PIC dies comprises the first PIC die and the second PIC die.
Example 9 includes the subject matter of any of Examples 1-8, and further including an electronic integrated circuit (EIC) die stacked on top of the second PIC die.
Example 10 includes the subject matter of any of Examples 1-9, and further including one or more vias extending from the EIC die to the second PIC die and one or more vias extending from the second PIC die to the first PIC die.
Example 11 includes the subject matter of any of Examples 1-10, and wherein the second PIC die is hybrid bonded to the first PIC die.
Example 12 includes the subject matter of any of Examples 1-11, and wherein a substrate of the first PIC die is a different type than a substrate of the second PIC die.
Example 13 includes a device comprising a first photonic integrated circuit (PIC) die, wherein a first plurality of waveguides are defined in the first PIC die; a second PIC die stacked on the first PIC die, wherein a second plurality of waveguides are defined in the second PIC die; and means for optically coupling the first plurality of waveguides and the second plurality of waveguides.
Example 14 includes the subject matter of Example 13, and wherein the means for optically coupling the first plurality of waveguides and the second plurality of waveguides comprises an optical bridge.
Example 15 includes the subject matter of any of Examples 13 and 14, and wherein the optical bridge comprises one or more mirrors, wherein the one or more mirrors direct beams from the first plurality of waveguides to the second plurality of waveguides.
Example 16 includes the subject matter of any of Examples 13-15, and wherein the optical bridge comprises a plurality of direct-write waveguides, wherein the plurality of direct-write waveguides guide light from the first plurality of waveguides to the second plurality of waveguides.
Example 17 includes the subject matter of any of Examples 13-16, and wherein the first PIC die comprises a first plurality of vertical couplers, wherein individual vertical couplers of the first plurality of vertical couplers are to couple light from individual waveguides of the first plurality of waveguides out of a surface of the first PIC die into individual direct-write waveguides of the plurality of direct-write waveguides, wherein the second PIC die comprises a second plurality of vertical couplers, wherein individual vertical couplers of the second plurality of vertical couplers are to couple light from individual waveguides of the second plurality of waveguides out of a surface of the second PIC die into individual direct-write waveguides of the plurality of direct-write waveguides.
Example 18 includes the subject matter of any of Examples 13-17, and wherein the optical bridge comprises a plurality of photonic wire bonds, wherein the plurality of photonic wire bonds guide light from the first plurality of waveguides to the second plurality of waveguides.
Example 19 includes the subject matter of any of Examples 13-18, and wherein individual photonic wire bonds of the plurality of photonic wire bonds are evanescently coupled to individual waveguides of the first plurality of waveguides and evanescently coupled to individual waveguides of the second plurality of waveguides.
Example 20 includes the subject matter of any of Examples 13-19, and wherein the device comprises at least four PIC dies stacked on top of each other, wherein the at least four PIC dies comprises the first PIC die and the second PIC die.
Example 21 includes the subject matter of any of Examples 13-20, and further including an electronic integrated circuit (EIC) die stacked on top of the second PIC die.
Example 22 includes the subject matter of any of Examples 13-21, and further including one or more vias extending from the EIC die to the second PIC die and one or more vias extending from the second PIC die to the first PIC die.
Example 23 includes the subject matter of any of Examples 13-22, and wherein the second PIC die is hybrid bonded to the first PIC die.
Example 24 includes the subject matter of any of Examples 13-23, and wherein a substrate of the first PIC die is a different type than a substrate of the second PIC die.
Example 25 includes a method comprising preparing a plurality of photonic integrated circuit (PIC) dies, wherein individual PIC dies of the plurality of PIC dies comprise a plurality of waveguides; testing individual PIC dies of the plurality of PIC dies to determine a plurality of non-faulty PIC dies; stacking two or more of the plurality of non-faulty PIC dies; and optically coupling the pluralities of waveguides of the two or more of the plurality of non-faulty PIC dies to each other.
Example 26 includes the subject matter of Example 25, and wherein the two or more of the plurality of non-faulty PIC dies comprises a first PIC die and a second PIC die, wherein optically coupling the pluralities of waveguides of the two or more of the plurality of non-faulty PIC dies to each other comprises optically coupling the plurality of waveguides of the first PIC die to the plurality of waveguides of the second PIC die with an optical bridge.
Example 27 includes the subject matter of any of Examples 25 and 26, and wherein the optical bridge comprises one or more mirrors, wherein the one or more mirrors direct beams from the plurality of waveguides of the first PIC die to the plurality of waveguides of the second PIC die.
Example 28 includes the subject matter of any of Examples 25-27, and wherein the optical bridge comprises a plurality of direct-write waveguides, wherein the plurality of direct-write waveguides guide light from the plurality of waveguides of the first PIC die to the plurality of waveguides of the second PIC die.
Example 29 includes the subject matter of any of Examples 25-28, and wherein the first PIC die comprises a first plurality of vertical couplers, wherein individual vertical couplers of the first plurality of vertical couplers are to couple light from individual waveguides of the plurality of waveguides of the first PIC die out of a surface of the first PIC die into individual direct-write waveguides of the plurality of direct-write waveguides, wherein the second PIC die comprises a second plurality of vertical couplers, wherein individual vertical couplers of the second plurality of vertical couplers are to couple light from individual waveguides of the plurality of waveguides of the second PIC die out of a surface of the second PIC die into individual direct-write waveguides of the plurality of direct-write waveguides.
Example 30 includes the subject matter of any of Examples 25-29, and wherein the optical bridge comprises a plurality of photonic wire bonds, wherein the plurality of photonic wire bonds guide light from the plurality of waveguides of the first PIC die to the plurality of waveguides of the second PIC die.
Example 31 includes the subject matter of any of Examples 25-30, and wherein individual photonic wire bonds of the plurality of photonic wire bonds are evanescently coupled to individual waveguides of the plurality of waveguides of the first PIC die and evanescently coupled to individual waveguides of the plurality of waveguides of the second PIC die.
Example 32 includes the subject matter of any of Examples 25-31, and wherein the two or more of the plurality of non-faulty PIC dies comprises at least four PIC dies.
Example 33 includes the subject matter of any of Examples 25-32, and further including an electronic integrated circuit (EIC) die stacked on top of the plurality of non-faulty PIC dies.
Example 34 includes the subject matter of any of Examples 25-33, and further including one or more vias extending from the EIC die to the plurality of non-faulty PIC dies.
Example 35 includes the subject matter of any of Examples 25-34, and wherein the plurality of non-faulty PIC dies are hybrid bonded together.
Example 36 includes the subject matter of any of Examples 25-35, and wherein the plurality of non-faulty PIC dies comprise two or more different types of substrates.

1-25. (canceled)

26. A device comprising:
a first photonic integrated circuit (PIC) die, wherein a first plurality of waveguides are defined in the first PIC die; and
a second PIC die stacked on the first PIC die, wherein a second plurality of waveguides are defined in the second PIC die, wherein individual waveguides of the first plurality of waveguides are optically coupled to individual waveguides of the second plurality of waveguides.

27. The device of claim 26, further comprising an optical bridge, wherein the optical bridge optically couples the first plurality of waveguides to the second plurality of waveguides.

28. The device of claim 27, wherein the optical bridge comprises one or more mirrors, wherein the one or more mirrors direct beams from the first plurality of waveguides to the second plurality of waveguides.

29. The device of claim 27, wherein the optical bridge comprises a plurality of direct-write waveguides, wherein the plurality of direct-write waveguides guide light from the first plurality of waveguides to the second plurality of waveguides.

30. The device of claim 29, wherein the first PIC die comprises a first plurality of vertical couplers, wherein individual vertical couplers of the first plurality of vertical couplers are to couple light from individual waveguides of the first plurality of waveguides out of a surface of the first PIC die into individual direct-write waveguides of the plurality of direct-write waveguides,
wherein the second PIC die comprises a second plurality of vertical couplers, wherein individual vertical couplers of the second plurality of vertical couplers are to couple light from individual waveguides of the second plurality of waveguides out of a surface of the second PIC die into individual direct-write waveguides of the plurality of direct-write waveguides.

31. The device of claim 27, wherein the optical bridge comprises a plurality of photonic wire bonds, wherein the plurality of photonic wire bonds guide light from the first plurality of waveguides to the second plurality of waveguides.

32. The device of claim 31, wherein individual photonic wire bonds of the plurality of photonic wire bonds are evanescently coupled to individual waveguides of the first plurality of waveguides and evanescently coupled to individual waveguides of the second plurality of waveguides.

33. The device of claim 26, wherein the device comprises at least four PIC dies stacked on top of each other, wherein the at least four PIC dies comprises the first PIC die and the second PIC die.

34. The device of claim 26, further comprising an electronic integrated circuit (EIC) die stacked on top of the second PIC die.

35. The device of claim 34, further comprising one or more vias extending from the EIC die to the second PIC die and one or more vias extending from the second PIC die to the first PIC die.

36. The device of claim 26, wherein the second PIC die is hybrid bonded to the first PIC die.

37. The device of claim 26, wherein a substrate of the first PIC die is a different type than a substrate of the second PIC die.

38. A device comprising:
a first photonic integrated circuit (PIC) die, wherein a first plurality of waveguides are defined in the first PIC die;
a second PIC die stacked on the first PIC die, wherein a second plurality of waveguides are defined in the second PIC die; and
means for optically coupling the first plurality of waveguides and the second plurality of waveguides.

39. The device of claim 38, wherein the means for optically coupling the first plurality of waveguides and the second plurality of waveguides comprises an optical bridge.

40. The device of claim 39, wherein the optical bridge comprises one or more mirrors, wherein the one or more mirrors direct beams from the first plurality of waveguides to the second plurality of waveguides.

41. The device of claim 39, wherein the optical bridge comprises a plurality of direct-write waveguides, wherein the plurality of direct-write waveguides guide light from the first plurality of waveguides to the second plurality of waveguides.

42. A method comprising:
preparing a plurality of photonic integrated circuit (PIC) dies, wherein individual PIC dies of the plurality of PIC dies comprise a plurality of waveguides;
testing individual PIC dies of the plurality of PIC dies to determine a plurality of non-faulty PIC dies;
stacking two or more of the plurality of non-faulty PIC dies; and
optically coupling the pluralities of waveguides of the two or more of the plurality of non-faulty PIC dies to each other.

43. The method of claim 42, wherein the two or more of the plurality of non-faulty PIC dies comprises a first PIC die and a second PIC die, wherein optically coupling the pluralities of waveguides of the two or more of the plurality of non-faulty PIC dies to each other comprises optically coupling the plurality of waveguides of the first PIC die to the plurality of waveguides of the second PIC die with an optical bridge.

44. The method of claim 43, wherein the optical bridge comprises a plurality of direct-write waveguides, wherein the plurality of direct-write waveguides guide light from the plurality of waveguides of the first PIC die to the plurality of waveguides of the second PIC die.

45. The method of claim 44, wherein the first PIC die comprises a first plurality of vertical couplers, wherein individual vertical couplers of the first plurality of vertical couplers are to couple light from individual waveguides of the plurality of waveguides of the first PIC die out of a surface of the first PIC die into individual direct-write waveguides of the plurality of direct-write waveguides,
wherein the second PIC die comprises a second plurality of vertical couplers, wherein individual vertical couplers of the second plurality of vertical couplers are to couple light from individual waveguides of the plurality of waveguides of the second PIC die out of a surface of the second PIC die into individual direct-write waveguides of the plurality of direct-write waveguides.
